(19) United States
(12) Patent Application Publication
(10) Pub. No.: US 2026/0368723 A1
(43) Pub. Date: Nov. 19, 2026

(54) DETERMINING A SYSTEM STATE USING A BLOCKCHAIN

(71) Applicant: nChain Licensing AG, Zug (CH)

(72) Inventors: Wei ZHANG, London (GB); Craig Steven WRIGHT, London (GB)

(21) Appl. No.: 19/167,356

(22) PCT Filed: Feb. 29, 2024
(86) PCT No.: PCT/EP2024/055198

§ 371 Date: Sep. 19, 2025

(30) Foreign Application Priority Data
Mar. 21, 2023 (GB) 2304098.3

(51) Int. Cl. G06Q 20/38; G06Q 20/40

(52) U.S. Cl. CPC G06Q 20/389; G06Q 20/401

(57) ABSTRACT

A computer-implemented method of determining a state of a system using one or more blockchain transactions, wherein each blockchain transaction comprises one or more outputs, and wherein the method is performed by a first party and comprises: identifying one or more outputs of a first blockchain transaction, wherein each output comprises a respective public key, and wherein each respective public key is associated with a respective state; and determining the state of the system based on the respective state associated with the respective public key of each of the identified one or more outputs.

### CROSS REFERENCE TO RELATED APPLICATIONS

This application is the U.S. National Stage of International Application No. PCT/EP2024/055198 filed on Feb. 29, 2024, which claims the benefit of United Kingdom Patent Application No. 2304098.3, filed on Mar. 21, 2023, the contents of which are all incorporated herein by reference in their entireties.

### TECHNICAL FIELD

The present disclosure relates to a method of using a blockchain to determine a state of a system, and, in some embodiments, influencing a state of the system using the blockchain.

### BACKGROUND

In an “output-based” blockchain model (sometimes referred to as a UTXO-based model), such as Bitcoin, the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets.

### SUMMARY

According to one aspect disclosed herein, there is provided a computer-implemented method of determining a state of a system using one or more blockchain transactions, wherein each blockchain transaction comprises one or more outputs, and wherein the method is performed by a first party and comprises: identifying one or more outputs of a first blockchain transaction, wherein each output comprises a respective public key, and wherein each respective public key is associated with a respective state; and determining the state of the system based on the respective state associated with the respective public key of each of the identified one or more outputs.

Bitcoin was invented not only for electronic cash (“coin”) but also for information (“bit”). The present disclosure utilises the “bit” information from the Bitcoin system (and other UTXO-based blockchain) literally. More specifically, the UTXO set may be used as a source of the information, where the status of each transaction outpoint represents one bit, 0 or 1, depending on whether the outpoint is in the UTXO set.

Some embodiments use the spending status of a blockchain transaction output to represent a binary value, and multiple of them to represent a binary string, where the binary value or string is interpreted as the state of a system. Some embodiments allow to change the state of a system by spending transaction outputs. Some embodiments use public keys to represent a value which can be interpreted according to a pre-agreed policy or rule, and use the status of the corresponding transaction outputs to indicate whether the values are up-to-date.

Generally speaking, embodiments of the present disclosure leverage a (e.g. public) blockchain as a single source of information for the state of a system that can be accessed anywhere at any time. Moreover, by recording state transitions as well as the entities responsible for the transitions on the blockchain, it provides an immutable system log for e.g. auditing, data analysis, or investigations.

Some embodiments may be used to implement a validity check on a system, such as that in identity management systems and access control systems. In some embodiments, the system has non-binary states and therefore multiple outpoints may be used to represent the state of the system. That is, n outpoints may be used to reflect any of 2\hat{ }n states of that system.

As an illustrative use case, a vending machine may be given the authorisation to change the state of its stock. Anyone can monitor the stock of the vending machine from the blockchain. E.g., a student may choose to only leave their dormitory room if they know that the vending machine downstairs has their favourite snack in stock; a snack provider may monitor the stock level on the blockchain and replenish it when needed; an administrator may monitor the sales of different flavours and adjust the supply if needed. All data is in one place, accessible anywhere in the world at any time.

Embodiments may also be used to manage IoT devices, e.g. to view and control the state of the devices. A user may monitor the blockchain to control a home device such as a washing machine or oven.

As another example, embodiments may be sued as a part of an aircraft take-off procedure. Each of a list of UTXOs may be associated with a task to be completed. The UTXO is spent when the task is completed, and the aircraft can only take-of when each UTXO has been spent.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain, and

FIG. 3 schematically illustrates an example system for determining a state of a system using a blockchain.

### DETAILED DESCRIPTION OF EMBODIMENTS

### 1. State Determination

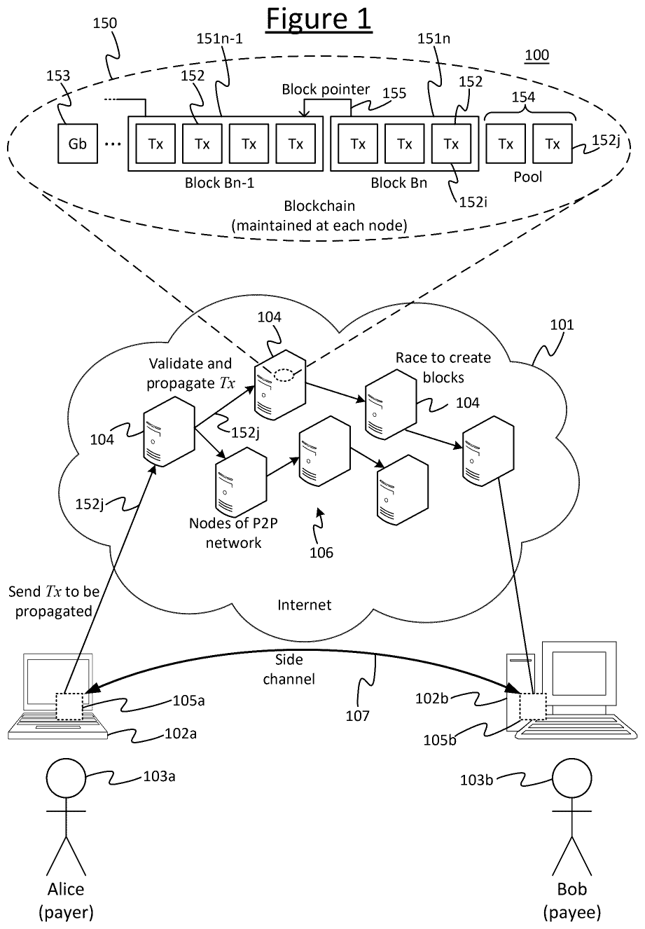

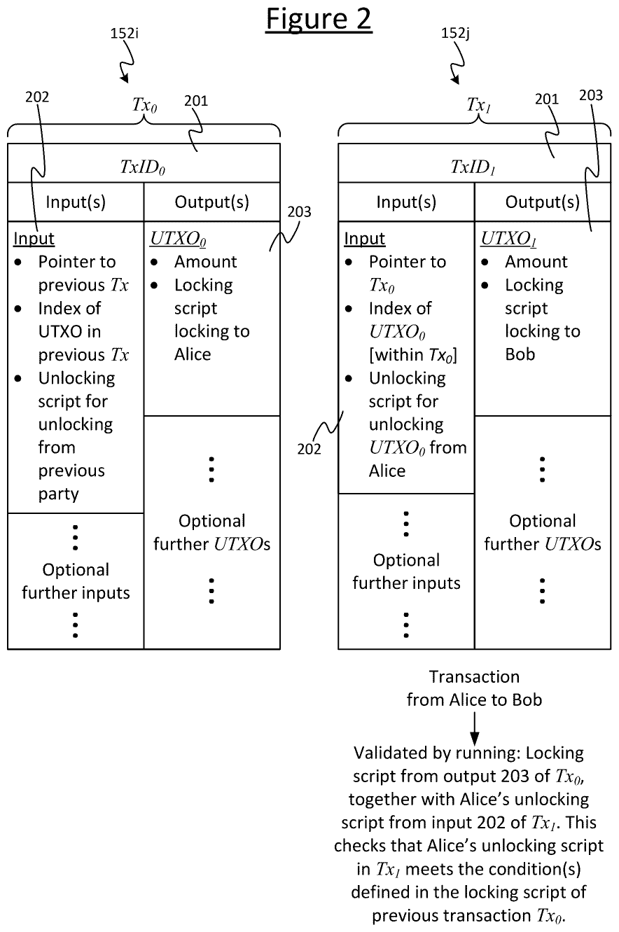

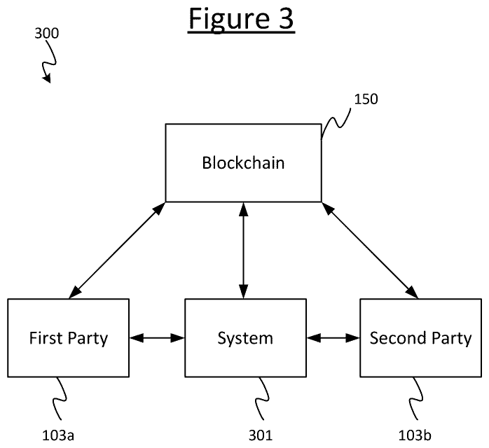

FIG. 3 illustrates an example system 300 that may be used to determine and influence the state of a system 301 using a blockchain 150. The example system 300 include a first party and a second party. For convenience, the first party will be referred to as Alice 103a and the second party will be referred to as Bob 103b, but in general each of the first and second parties operate respective computing equipment 102 and may be configured to perform any of the actions described below as being performed by Alice 103a and/or Bob 103b with reference to FIGS. 1 and 2.

The system 301 may take any form. It may be a physical system made up of one or more physical components, e.g. computing devices. As illustrative examples, the system 301 may comprise a physical entry component, such as a door, a gate, a barrier, etc. The system 301 may comprise a user identity component, such as a physical identity card, a fingerprint scanner, a retina scanner, and so on. The system 301 may be a virtual system with which Alice 103a and/or Bob 103b may interact. The system 301 may comprise both physical and virtual components.

As shown in FIG. 3, each of Alice 103a, Bob 103b and the system 301 itself may interact with the blockchain 150. This may include sending one or more transactions to blockchain nodes 104 of a blockchain network 106 to be recorded on the blockchain 150. Additionally or alternatively, this may include obtaining data from the blockchain 150, e.g. via one or more blockchain nodes 104.

In some embodiments, the system 301 is associated with one or more UTXOS. The status of the one or more UTXOs represent the state of the system 301. One or more of the UTXOs may be controlled by Alice 103a and/or Bob 103b, e.g. some controlled by Alice 103a and some by Bob 103b. One or more of the UTXOs may be chosen arbitrarily, e.g. to introduce randomness into the system 301. In some examples, the UTXOs associated with the system 301 are those comprising a particular public key, or a public key from a particular set of public keys.

Alice 103a may determine the state of the system 301 based on the UTXOs. That is, Alice 103a determines a respective status (i.e. spent or unspent) of the one or more UTXOs associated with the system 301. The state of the system 301 is then determined based on the respective statuses of the UTXO(s).

In some examples, Alice 103a maps the status of each UTXO to a value. Each UTXO can be in (i.e. have, be associated with, etc.) either a first status (e.g. spent) or a second status (e.g. unspent). Each output having the first status is assigned one value (e.g. 1), and each output having the second status is assigned a different value (e.g. 0). Alice 103a may then determine the state of the system 301 based on the values mapped to the UTXOs. As a particular example, Alice 103a may generate a binary string based on the values, where the binary string determines the state of the system 301. For instance, each UTXO may be mapped to a position in the string, e.g. a first UTXO mapped to a first digit in the string, a second UTXO mapped to a second digit in the string, etc. The respective status of the particular UTXOs thus determines the digits at the corresponding positions in the string.

In some examples, Alice 103a may determine the status of the system 301 at a first time, and then at one or more future times.

In examples in which Alice 103a controls one or more of the UTXOs, Alice 103a may change the state of the system 301 by spending one or more UTXOs. The system 301 may perform an action in response to said spendings of the one or more UTXOs.

In some embodiments, the system 301 is associated with one or more UTXOS, where each UTXO includes a public key (or a hash thereof). Each public key is associated with a state. Alice 103a determines the state of the system based on the state associated with each public key. As in the embodiments described above, one or more of the UTXOs may be controlled by Alice 103a and/or Bob 103b.

Alice 103a may determine the state of the system 301 based on both the public key(s) and the status of the output(s) comprising the public key(s). That is, Alice 103a determines a respective status (i.e. spent or unspent) of the one or more UTXOs associated with the system 301. Each UTXO may have a first status (e.g. unspent) or a second status (e.g. spent). If the UTXO has the first status, Alice 103a determines that the public key comprised by that UTXO represents a current state. Conversely, if the UTXO has the second status, Alice 103a determines that the public key comprised by that UTXO does not represent a current state. Alice 103a may determines the state of the system 301 based on the public keys representing a current state of the system 301.

Alice 103a may, in response to determining a UTXO has the second status (e.g. spent), identify a transaction (a “spending transaction”) that references the UTXO. The state of the system 301 is then determined, at least in part, based on one or more UTXOs of the spending transaction. More specifically, the state of the system 301 is determined based on one or more respective public keys included in one or more respective outputs of the spending transaction. The process may be repeated for each UTXO that has the second status.

In the case where a respective UTXO is referenced by a respective spending transaction, Alice 103a may verify that the spending transaction contains a signature associated with the public key of the UTXO. Alice 103a may choose to only determine the state of the system 301 if the spending transaction does include a valid signature.

Note that one or more public keys from later UTXOs (i.e. UTXOs found in spending transactions) may be the same as one or more public keys from earlier UTXOS, and therefore represent the same state. This allows the state (or at least part of the state) of the system 301 to return to a previous state.

The system 301 may have an initial (i.e. starting state). Alice 103a may determine the initial state of the system 301 by identifying an ‘initial transaction’, and determining the initial state based on the respective state(s) represented by the public key(s) included in the initial transaction, or rather the output(s) thereof. Alice 103a may identify the initial transaction based on its transaction identifier, or based on a particular public key included in the initial transaction. That is, the transaction identifier or the public key may be known to be associated with the initial transaction. The public key may be included in an input or an output of the initial transaction.

Similarly, Alice 103a may determine a final state of the system 301 by identifying a ‘final transaction’, and determining the final state based on the respective state(s) represented by the public key(s) included in the initial transaction, or rather the output(s) thereof. In some examples, the final transaction includes a public key that is known to be associated with the final state of the system 301.

As in the embodiments described above, Alice 103a may map each public key (or the state represented by that public key) to a value, and generate a string, e.g. a binary string, based on the values. The state of the system 301 may be determined based on the string.

Alice 103a and/or Bob 103b may change the state of the system 301 by changing the status of one or more outputs of one or more of the transactions associated with the system 301, e.g. by spending an output having a public key that represents a state of the system 301. This may involve generating a signature using a private key corresponding to the public key.

In some embodiments, the system 301 may have an initial state that is represented by one or more ‘initial public keys’. That is, each initial public key represents at least part of the state of the system 301. Alice 103a determines an initial state of the system 301 based on the initial public keys. For instance, each initial public key may be mapped to a value, and the one or more values mapped to the one or more initial public keys may form a string (e.g. binary string). The string may represent the state of the system 301. In these embodiments, the blockchain 150 includes one or more outputs comprising a respective initial public key. The outputs may be locked to the initial public keys. The outputs may be distributed across multiple initial transactions (e.g. one per transaction), or all included in a single initial transaction. In some examples, one or more outputs are controlled by Alice 103a and/or Bob 103b.

Alice 103a identifies one or more final transactions. Each final transaction includes a respective reference to a respective output of an initial transaction, e.g. each final transaction includes at least one respective input that spends a respective output of an initial transaction. A final transaction may include multiple references to multiple respective outputs of the same initial transaction or different initial transactions. Each final transaction includes at least one output comprising a final public key, e.g. the output may be locked to the final public key. Each final public key represents at least part of the state of the system 301. Alice 103a determines a final state of the system 301 based on the final public keys. For instance, each final public key may be mapped to a value, and the one or more values mapped to the one or more final public keys may form a string (e.g. binary string). The string may represent the final state of the system 301. The final transaction(s) may be identified by identifying transactions having at least one signature corresponding to at least one of the initial public keys. Alice 103a and/or Bob 103b may be responsible for creating one or more for the final transactions and thus changing the state of the system 301.

Alice 103a may wait until each of the outputs of the initial transaction(s) have been spent, by a respective input of the final transaction(s), before determining the final state of the system 301. Alternatively, Alice 103a may determine the final state after a predetermined time period (e.g. from the initial transaction(s) being recorded on the blockchain, or from a particular point in time), or at a predetermined time, e.g. on a particular date.

In some examples, Alice 103a may determine the final state of the system based on certain ones of the final public keys, e.g. those belonging to a predetermined set of public keys. That is, the state of the system 301 may only be allowed to change if particular public keys are used, e.g. those representing particular states.

### 1.1 Blockchain as a Binary Encoder

This section provides further illustrative examples of the embodiment described above. It will be appreciated that some features are optional and not required in all embodiments.

### 1.1 Uni-Directional States

In this example, the state of a system is mapped to a binary string. Each bit of the string is represented by a transaction output. The spending status of the output (i.e. whether it is in the UTXO set) represents the value of the bit. The locking script in each output can be used to enforce access control. A locking script and its unlocking script can be used to offer authenticity. In general any UTXOS can be used. In some examples, the UTXO's controlled by a particular party are used, where the ability to spend UTXOs implies the ability to control the system. For example, the system may comprise one or more lights in a building, where only occupants of the building are able to turn the lights on and off.

For example, a system with four states can be represented by two transaction outputs. TXID₀∥0 and TXID₀∥1. When both are unspent, the state is “11”. By spending TXID₀∥0 or TXID₀∥1, the state transits to “01” or “10”, respectively. By spending both outputs, the state becomes “00”. As a spent output cannot be unspent again, “00” will be the final state of the system.

Another example use case is a two-factor authentication system, or a two-party authentication system that is used to access a system. The initial state is “11”, indicating the system is locked to a user. Once one factor or one party passes verification (spending one of the outputs), the state becomes “01” or “10”, indicating the system is half unlocked. When the other factor or the other party passes verification (spending the other output), the state becomes “00”, indicating the system is fully unlocked. (A lawyer observing the state becoming “00” starts to follow a list of instructions in the will of their client.)

### 1.1.2 Bi-Directional States

In the previous example, when “1” is changed to “0”, it cannot be changed back. To address this limitation for some use cases, public keys may be used in addition to the spending status of a transaction output. Suppose that the public key

$${PK}_{0 \to 1}^{i}$$

is certified to have the authorisation to change “0” to “1” for the i-th bit of the string, similarly for

$$P {K}_{1 \to 0}^{i} ,$$

which has the authorisation to change from “1” to “0”. A dedicated public key PKᵢₙᵢₜ, which is certified, may be used to initialise the state of a system, and another one PK_{fin} to indicate that no more state changes are allowed. This can be illustrated by the following four transactions as an example.

TxID₀
Locktime 0

| Input list | | Output list | |
|---|---|---|---|
| Outpoint | Unlocking script | Value | Locking script |
| Outpointᵢₙ | < Sigᵢₙᵢₜ > | x₀ | $[ P 2 PKH {PK}_{1 \to 0}^{0} ]$ |
| | < PKᵢₙᵢₜ > | x₁ | $[ P 2 PKH {PK}_{1 \to 0}^{1} ]$ |

The transaction TXID₀ initialises the state of a four-state system as “11”. To read or verify the state, the following guidance is followed.
1. The public key in the unlocking script PKᵢₙᵢₜ implies that this is the initialisation of a state. There is no need to read the previous state.
2. Both public keys in the locking scripts indicate a value of “1”.
3. Both transaction outputs are unspent. Therefore, one can conclude that the current state is “11”.

TxID₁
Locktime 0

| Input list | | Output list | |
|---|---|---|---|
| Outpoint | Unlocking script | Value | Locking script |
| TXID₀\|\|0 | $< {Sig}_{1 \to 0}^{0} >$ | x₂ | $[ P 2 PKH {PK}_{0 \to 1}^{0} ]$ |
| | $< {PK}_{1 \to 0}^{0} >$ | | |

The transaction TXID₁ changes the value of the first bit from “1” to “0”, resulting in a state of “01”. To read or verify the state, the following guidance is followed.
1. Given TXID₀, one can see that the initial state is “11”.
2. Given TXID₁, one can see that a valid signature is provided with respect to

$${PK}_{1 \to 0}^{0} , and {PK}_{0 \to 1}^{0}$$

is included in the locking script as expected.
3. As both TXID₁∥0 and TXID₀∥1 are unspent, one can conclude that the current state is “01”.

In short, while providing an access control framework, public keys are also used to represent a state, and the spending status of the corresponding outputs are used to indicate whether the state is the latest one.

TxID₂
Locktime 0

| Input list | | Output list | |
|---|---|---|---|
| Outpoint | Unlocking script | Value | Locking script |
| TXID₁\|\|0 | $< {Sig}_{0 \to 1}^{0} >$ | x₃ | $[ P 2 PKH {PK}_{1 \to 0}^{0} ]$ |
| | $< {PK}_{0 \to 1}^{0} >$ | | |
| TXID₀\|\|1 | $< {Sig}_{1 \to 0}^{1} >$ | x₄ | $[ P 2 PKH {PK}_{0 \to 1}^{1} ]$ |
| | $< {PK}_{1 \to 0}^{1} >$ | | |

To change from “0” back to “1”, the certified public key

$${PK}_{0 \to 1}^{0}$$

may be used as shown in TXID₂. Another input-output pair is included to indicate the change of the second bit from “1” to “0”. As before, to read or verify the state, public keys are used to extract the value, and the spending status is used to check whether the value is up-to-date. In this case, it can be concluded that the latest state has value of “10”.

TxID₃
Locktime 0

| Input list | | Output list | |
|---|---|---|---|
| Outpoint | Unlocking script | Value | Locking script |
| TXID₂\|\|0 | $< {Sig}_{1 \to 0}^{0} >$ | x₅ | [P2PKH PK_{fin}] |
| | $< {PK}_{1 \to 0}^{0} >$ | | |
| TXID₂\|\|1 | $< {Sig}_{0 \to 1}^{1} >$ | | |
| | $< {PK}_{0 \to 1}^{1} >$ | | |

Finally, it can be concluded the state change by spending both outputs in TXID₂ to PK_{fin} as shown in TXID₃. Depending on the system design, one can consider the last state of the system being the final state of the system, or having a particular state, e.g., “00” as the default final state.

### 1.1.3 Public Key Interpretation

A further generalisation may be made on the interpretation of the public keys. Taking voting for an election as an example, voters can be given a certified public key to vote. This initialises the voting system with a state of “11 . . . 1”, indicating that each voter is ready to vote. Each voter will spend their output to a public key in a set, each of which represents an election candidate. The voting ends after a given date or when the state reaches “00 . . . 0”. The locktime of a transaction may be used to automatically spend an output if the output is not spent by the voter. The public keys may be set up in such a way that the privacy of the voter is preserved, e.g., using zero knowledge proof or Diffie-Helman-style key derivation. When the underlying blockchain is public, everyone is able to tell how many voters have voted and how many votes each candidate has, but nothing else. Outputs that are not spent to the right set of public keys are considered invalid votes. This results in a robust voting system with transparency as well as privacy.

### 2. Example System Overview

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 3. UTXO-Based Model

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx-”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx/further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 4. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method of determining a state of a system using one or more blockchain transactions, wherein each blockchain transaction comprises one or more outputs, and wherein the method is performed by a first party and comprises:
identifying one or more outputs of a first blockchain transaction, wherein each output comprises a respective public key, and wherein each respective public key is associated with a respective state; and
determining the state of the system based on the respective state associated with the respective public key of each of the identified one or more outputs.

Statement 2. The method of statement 1, comprising:
determining a respective status of the one or more respective outputs, wherein each respective output can have either a first status or a second status, wherein the first status indicates that the respective public key of the respective output represents a current state, and wherein the second status indicates that the respective public key of the respective output does not represent a current state, and wherein said determining of the state of the system is based on the respective status of the one or more respective outputs.

Statement 3. The method of statement 2, comprising:
in response to determining that a respective output of the first blockchain transaction has a second status, identifying one or more respective outputs of a second blockchain transaction comprising an input that references the respective output of the first blockchain transaction, each respective output comprising a respective public key associated with a respective state, and each respective output having the first status; and
determining the state of the system based on the respective state associated with the respective public key of each of the identified one or more outputs having the first status.

Statement 4. The method of statement 3, comprising:
verifying that the input of the second blockchain transaction comprises a signature corresponding to the respective public key of the respective output of the first blockchain transaction having the second status, wherein said determining of the state of the system is dependent on said verification passing.

Statement 5. The method of statement 3 or statement 4, comprising:
in response to determining that a respective output of the second blockchain transaction has a second status, identifying one or more respective outputs of a third blockchain transaction comprising an input that references the respective output of the second blockchain transaction, each respective output comprising a respective public key associated with a respective state, and each respective output having the first status; and
determining the state of the system based on the respective state associated with the respective public key of each of the identified one or more outputs having the first status.

Statement 6. The method of statement 5, wherein the respective public key of at least one output of the third blockchain transaction is associated with the same respective state associated with the respective public key of at least one output of the first blockchain transaction.

Statement 7. The method of any preceding statement, comprising:
determining an initial state of the system by identifying an initial blockchain transaction, wherein the initial blockchain transaction comprises one or more outputs, wherein each output comprises a respective public key, and wherein each respective public key is associated with respective initial state; and
determining the state of the system based on the respective initial state associated with the respective public key of each of the outputs of the initial blockchain transaction.

Statement 8. The method of statement 7, wherein the initial blockchain transaction comprises an initial public key indicating that the initial blockchain transaction represents the initial state of the system.

Statement 9. The method of statement 7 or statement 8, wherein the first blockchain transaction is the initial blockchain transaction.

Statement 10. The method of any preceding statement, comprising:
determining a final state of the system by identifying a final blockchain transaction, wherein the final blockchain transaction comprises an output comprising a final public key, and wherein the final public key; and
determining the state of the system based on either:
   a final state associated with the final public key, or
   a respective state associated with the respective public key of each of one or more outputs referenced by one or more respective inputs of the final blockchain transaction.

Statement 11. The method of any preceding statement, wherein each respective state is associated with a respective value, and wherein the method comprises:
generating a binary string based on the respective value mapped to the respective status of the one or more respective outputs, wherein said determining of the state of the system is based on the binary string.

Statement 12. The method of any preceding statement, comprising:
changing the state of the system by changing the respective status of one or more of the respective outputs.

Statement 13. The method of any preceding statement, wherein the respective status is a spending status, wherein the first status is an unspent status and wherein the second status is a spent status.

Statement 14. The method of statement 12 and statement 13, wherein changing the respective status of the one or more of the respective outputs comprises spending the one or more of the respective outputs.

Statement 15. The method of any preceding statement, wherein the one or more respective outputs of comprises a plurality of respective outputs.

Statement 16. The method of any preceding statement, wherein the system is a physical system.

Statement 17. The method of any preceding statement, wherein one or more of the one or more respective outputs are controlled by a predetermined party.

Statement 18. The method of statement 17, wherein the predetermined party is the first party or a different, second party.

Statement 19. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 18.

Statement 20. A computer program embodied on computer-readable storage and configured so as, when run on one or more processors, to perform the method of any of statements 1 to 18.

1. A computer-implemented method of determining a state of a system using one or more blockchain transactions, wherein each blockchain transaction comprises one or more outputs, and wherein the method is performed by a first party and comprises:
identifying one or more outputs of a first blockchain transaction, wherein each output comprises a respective public key, and wherein each respective public key is associated with a respective state; and
determining the state of the system based on the respective state associated with the respective public key of each of the identified one or more outputs.

2. The method of claim 1, comprising:
determining a respective status of the one or more respective outputs, wherein each respective output can have either a first status or a second status, wherein the first status indicates that the respective public key of the respective output represents a current state, and wherein the second status indicates that the respective public key of the respective output does not represent a current state, and wherein said determining of the state of the system is based on the respective status of the one or more respective outputs.

3. The method of claim 2, comprising:
in response to determining that a respective output of the first blockchain transaction has a second status, identifying one or more respective outputs of a second blockchain transaction comprising an input that references the respective output of the first blockchain transaction, each respective output comprising a respective public key associated with a respective state, and each respective output having the first status; and
determining the state of the system based on the respective state associated with the respective public key of each of the identified one or more outputs having the first status.

4. The method of claim 3, comprising:
verifying that the input of the second blockchain transaction comprises a signature corresponding to the respective public key of the respective output of the first blockchain transaction having the second status, wherein said determining of the state of the system is dependent on said verification passing.

5. The method of claim 3, comprising:
in response to determining that a respective output of the second blockchain transaction has a second status, identifying one or more respective outputs of a third blockchain transaction comprising an input that references the respective output of the second blockchain transaction, each respective output comprising a respective public key associated with a respective state, and each respective output having the first status; and
determining the state of the system based on the respective state associated with the respective public key of each of the identified one or more outputs having the first status.

6. The method of claim 5, wherein the respective public key of at least one output of the third blockchain transaction is associated with the same respective state associated with the respective public key of at least one output of the first blockchain transaction.

7. The method of claim 1, comprising:
determining an initial state of the system by identifying an initial blockchain transaction, wherein the initial blockchain transaction comprises one or more outputs, wherein each output comprises a respective public key, and wherein each respective public key is associated with respective initial state; and
determining the state of the system based on the respective initial state associated with the respective public key of each of the outputs of the initial blockchain transaction.

8. The method of claim 7, wherein the initial blockchain transaction comprises an initial public key indicating that the initial blockchain transaction represents the initial state of the system.

9. The method of claim 7, wherein the first blockchain transaction is the initial blockchain transaction.

10. The method of claim 1, comprising:
determining a final state of the system by identifying a final blockchain transaction, wherein the final blockchain transaction comprises an output comprising a final public key, and wherein the final public key; and
determining the state of the system based on either:
a final state associated with the final public key, or
a respective state associated with the respective public key of each of one or more outputs referenced by one or more respective inputs of the final blockchain transaction.

11. The method of claim 1, wherein each respective state is associated with a respective value, and wherein the method comprises:
generating a binary string based on the respective value mapped to a respective status of the one or more respective outputs, wherein said determining of the state of the system is based on the binary string.

12. The method of claim 2, comprising:
changing the state of the system by changing the respective status of one or more of the respective outputs.

13. The method of claim 2, wherein the respective status is a spending status, wherein the first status is an unspent status and wherein the second status is a spent status.

14. The method of claim 12, wherein the respective status is a spending status, wherein the first status is an unspent status and wherein the second status is a spent status, and wherein changing the respective status of the one or more of the respective outputs comprises spending the one or more of the respective outputs.

15. The method of claim 1, wherein the one or more respective outputs of comprises a plurality of respective outputs.

16. The method of claim 1, wherein the system is a physical system.

17. The method of claim 1, wherein one or more of the one or more respective outputs are controlled by a predetermined party.

18. The method of claim 17, wherein the predetermined party is the first party or a different, second party.

19. Computer equipment comprising:
memory comprising one or more memory units; and
processing apparatus comprising one or more processing units, wherein the memory stores code arranged to run on the processing apparatus, the code being configured so as when on the processing apparatus to perform the method of determining a state of a system using one or more blockchain transactions, wherein each blockchain transaction comprises one or more outputs, and wherein the method is performed by a first party and comprises:
identifying one or more outputs of a first blockchain transaction, wherein each output comprises a respective public key, and wherein each respective public key is associated with a respective state; and
determining the state of the system based on the respective state associated with the respective public key of each of the identified one or more outputs.

20. A computer program embodied on computer-readable storage and configured so as, when run on one or more processors, to perform the method of determining a state of a system using one or more blockchain transactions, wherein each blockchain transaction comprises one or more outputs, and wherein the method is performed by a first party and comprises:
identifying one or more outputs of a first blockchain transaction, wherein each output comprises a respective public key, and wherein each respective public key is associated with a respective state; and
determining the state of the system based on the respective state associated with the respective public key of each of the identified one or more outputs.
